(19) United States
(12) Patent Application Publication
(10) Pub. No.: US 2011/0223840 A1
(43) Pub. Date: Sep. 15, 2011

(54) Polishing Composition and Polishing Method Using The Same

(75) Inventors: Hitoshi MORINAGA, Ichinomiya-shi (JP); Kazusei TAMAI, Inazawa-shi (JP); Hiroshi ASANO, Kakamigahara-shi (JP)

(73) Assignee: FUJIMI INCORPORATED, Kiyosu-shi (JP)

(21) Appl. No.: 13/042,643

(22) Filed: Mar. 8, 2011

(30) Foreign Application Priority Data
Mar. 10, 2010 (JP) 2010-053528
Mar. 3, 2011 (JP) 2011-046673

(51) Int. Cl. B24B 1/00; C09G 1/02

(52) U.S. Cl. 451/28; 51/307; 51/309

(57) ABSTRACT

A polishing composition contains at least abrasive grains and water and is used in polishing an object to be polished formed of a substrate material for optical devices, a substrate material for power devices, or a compound semiconductor material. The abrasive grains have a zeta potential satisfying the relationship X×Y≦0, where X [mV] represents the zeta potential of the abrasive grains measured in the polishing composition and Y [mV] represents the zeta potential of the object to be polished measured during polishing using the polishing composition. The abrasive grains are preferably of aluminum oxide, silicon oxide, zirconium oxide, diamond, or silicon carbide. The object to be polished is preferably of sapphire, gallium nitride, silicon carbide, gallium arsenide, indium arsenide, or indium phosphide.

### BACKGROUND OF THE INVENTION

The present invention relates to a polishing composition for use in polishing an object to be polished formed of a substrate material for optical devices, a substrate material for power devices, or a compound semiconductor material.

The substrate material for optical devices and the substrate material for power devices refer to, for example, ceramics including oxides such as sapphire, nitrides such as gallium nitride, and carbides such as silicon carbide. The compound semiconductor material refers to, for example, gallium arsenide, indium arsenide, or indium phosphide.

Since substrates or films formed of these materials usually remain stable with respect to chemical action such as oxidation, complexation, and etching, processing the substrates or the films by polishing is not easy. Accordingly, the processing is commonly performed by grinding or cutting using a hard material. However, a highly smooth surface cannot be produced by grinding or cutting.

In known methods for producing a highly smooth surface, a sapphire substrate is polished using a polishing composition containing a relatively high concentration of colloidal silica (for example, refer to Japanese Laid-Open Patent Publication No. 2008-44078), and a silicon carbide substrate is polished using a polishing composition containing colloidal silica with a specific pH (for example, refer to Japanese Laid-Open Patent Publication No. 2005-117027). However, a problem associated with these methods is that much time is required for producing highly smooth surfaces, since a sufficient polishing rate (removal rate) is not provided.

### SUMMARY OF THE INVENTION

Accordingly, an objective of the present invention is to provide a polishing composition for use in polishing an object to be polished formed of a substrate material for optical devices, a substrate material for power devices, or a compound semiconductor material at an enhanced rate of polishing, and another objective of the present invention is to provide a method of polishing using the composition.

To achieve the foregoing objectives, and in accordance with a first aspect of the present invention, a polishing composition containing at least abrasive grains and water is provided in which the abrasive grains have a zeta potential satisfying the relationship X×Y≦0, where X [mV] represents the zeta potential of the abrasive grains measured in the polishing composition and Y [mV] represents the zeta potential of an object to be polished measured during polishing using the polishing composition. The expression X×Y has a value preferably not lower than −5,000.

In accordance with a second aspect of the present invention, a polishing composition containing at least abrasive grains and water in which the abrasive grains have such a zeta potential value as not to be electrostatically repelled from an object to be polished during polishing using the polishing composition.

The abrasive grains contained in the polishing composition according to the first or the second aspect are preferably formed of aluminum oxide, silicon oxide, zirconium oxide, diamond, or silicon carbide. The object to be polished that is polished using the polishing composition according to the first or the second aspect is preferably formed of sapphire, gallium nitride, silicon carbide, gallium arsenide, indium arsenide, or indium phosphide. The polishing composition according to the first or the second aspect may further contain a pH adjuster or a substance that adsorbs to the object to be polished. The abrasive grains contained in the polishing composition according to the first or the second aspect may be surface-reformed.

In accordance with a third aspect of the present invention, provided is a method of polishing an object formed of a substrate material for optical devices, a substrate material for power devices, or a compound semiconductor material using the polishing composition according to the first or the second aspect.

Other aspects and advantages of the invention will become apparent from the following description illustrating by way of example the principles of the invention.

### DETAILED DESCRIPTION OF THE PREFERRED EMBODIMENTS

One embodiment of the present invention will now be described below.

A polishing composition of the present embodiment contains at least abrasive grains and water. The polishing composition is used in polishing an object to be polished formed of a substrate material for optical devices, a substrate material for power devices, or a compound semiconductor material, more specifically in polishing a substrate or a film formed of ceramics including oxides such as sapphire, nitrides such as gallium nitride, and carbides such as silicon carbide, or compound semiconductor material such as gallium arsenide, indium arsenide, or indium phosphide. The polishing composition is preferably used in polishing an object to be polished formed of a material that remains stable with respect to chemical action such as oxidation, complexation, and etching, in particular in polishing a substrate formed of sapphire, gallium nitride, or silicon carbide.

The abrasive grains contained in the polishing composition may be of, for example, aluminum oxide, silicon oxide, zirconium oxide, diamond, or silicon carbide, although not limited thereto. Aluminum oxide and silicon oxide have an advantage in easy availability for readily producing a highly smooth surface having few defects by polishing using the polishing composition.

The polishing composition contains preferably not less than 0.01% by mass, more preferably not less than 0.1% by mass of the abrasive grains. The more the amount of abrasive grains contained, the more enhanced becomes the rate of polishing an object to be polished using the polishing composition.

The polishing composition contains preferably not more than 50% by mass, more preferably not more than 40% by mass of the abrasive grains. The less the amount of abrasive grains contained, the more reduced becomes the cost of manufacturing the polishing composition. In addition, a polished surface having few scratches can be more readily produced by polishing using the polishing composition.

The polishing composition contains abrasive grains having a mean primary particle diameter of preferably not smaller than 5 nm, more preferably not smaller than 10 nm. The larger the mean primary particle diameter of the abrasive grains, the more enhanced becomes the rate of polishing an object to be polished using the polishing composition.

The polishing composition contains abrasive grains having a mean primary particle diameter of preferably not larger than 20 μm, more preferably not larger than 10 μm. The smaller the mean primary particle diameter of the abrasive grains, the more readily the surface having fewer defects and a small degree of roughness can be produced by polishing using the polishing composition. The mean primary particle diameter is calculated, for example, from the specific surface of the abrasive grains measured by the BET method. The specific surface of the abrasive grains is measured, for example, with a “Flow SorbII 2300” made by Micromeritics Instrument Corporation.

In order to polish an object formed of a substrate material for optical devices, a substrate material for power devices, or a compound semiconductor material at an enhanced rate of polishing using the polishing composition, it is important that the abrasive grains contained in the polishing composition are not electrostatically repelled from the object to be polished during polishing. For this reason, the abrasive grains for use have a zeta potential satisfying the relationship X×Y≦0, where X [mV] represents the zeta potential of the abrasive grains measured in the polishing composition and Y [mV] represents the zeta potential of the object to be polished measured during polishing using the polishing composition. When the relationship X×Y≦0 is not satisfied, that is, when the relationship X×Y>0 is satisfied, the abrasive grains contained in the polishing composition are electrostatically repelled from the object to be polished during polishing, which creates difficulty in mechanically polishing the object to be polished with the abrasive grains. As a result, it is difficult to polish the object to be polished at an enhanced rate of polishing using the polishing composition. The expression X×Y has a value preferably not higher than −20 for enhancing the rate of polishing an object to be polished to a level particularly suitable for practical use with the polishing composition.

The expression X×Y has a value of preferably not lower than −5,000, and more preferably not lower than −2,000. The higher the value of the expression X×Y, the more readily the abrasive grains attaching to the polished surface of the object to be polished can be removed by washing.

The zeta potential value of the abrasive grains measured in the polishing composition and the zeta potential value of the object to be polished measured during polishing using the polishing composition are affected, for example, by the pH of the polishing composition. Accordingly, the relationship X×Y≦0, preferably the relationship X×Y≦−20 may be satisfied with addition of one or more pH adjusters to the polishing composition. The pH adjuster for use may be either acid or alkali.

Alternatively, with addition of an adsorptive substance to the polishing composition, the zeta potential value of the object to be polished is varied with the substance adsorbed to the surface of the object to be polished. Accordingly, the relationship X×Y≦0, preferably the relationship X×Y≦−20 may be satisfied with addition of such an adsorptive substance to the polishing composition. The adsorptive substance for use is preferably appropriately selected depending on the types of objects to be polished, and may be, for example, an anionic, cationic, nonionic, or zwitterionic surfactant, an organic matter, or metal ions.

Alternatively, in order to satisfy the relationship X×Y≦0, preferably the relationship X×Y≦−20, the zeta potential of the abrasive grains may be adjusted by reforming the surface of the abrasive grains with doping or organic functional group modification.

The zeta potential values of the abrasive grains and the object to be polished are measured by an electrophoretic light scattering method or electroacoustic spectroscopy using, for example, an “ELS-Z” made by Otsuka Electronics Co., Ltd. or a “DT-1200” made by Dispersion Technology Inc. Measurement of the zeta potential of the object to be polished may be replaced with measurement of the zeta potential of fine particles composed of the same material as the object to be polished. Alternatively, the object to be polished is immersed in a liquid containing fine particles having a known zeta potential value, taken out from the liquid, and washed with running water for about 10 seconds, and then the surface of the object to be polished may be observed with, for example, a scanning electron microscope. In this case, whether a sign of the zeta potential value of the object to be polished measured in the liquid is positive or negative can be known from the amount of the fine particles attaching to the surface of the object to be polished after washing.

The present embodiment provides the following advantages.

In the polishing composition of the present embodiment, the abrasive grains for use have a zeta potential satisfying the relationship X×Y≦0, where X [mV] represents the zeta potential of the abrasive grains measured in the polishing composition and Y [mV] represents the zeta potential of the object to be polished measured during polishing using the polishing composition. Accordingly, the abrasive grains contained in the polishing composition have such a zeta potential value as not to be electrostatically repelled from the object to be polished during polishing using the polishing composition. Since the abrasive grains contained in the polishing composition are not electrostatically repelled from the object to be polished during polishing, mechanical polishing of the object to be polished is efficiently performed with the abrasive grains. As a result, an object to be polished formed of a substrate material for optical devices, a substrate material for power devices, or a compound semiconductor material can be polished at an enhanced rate of polishing using the polishing composition.

The embodiment may be modified as described below.

The polishing composition of the embodiment may contain two or more kinds of abrasive grains. In this case, part of the abrasive grains need not have such zeta potential values as not to be electrostatically repelled from the object to be polished during polishing. However, in order to achieve a more enhanced rate of polishing, the abrasive grains preferably have such zeta potential values as not to be electrostatically repelled from the object to be polished during polishing.

The polishing composition of the embodiment may further contain a known additive such as an antiseptic as needed.

The polishing composition of the embodiment may be prepared by diluting a concentrate of the polishing composition with water.

Examples and Comparative Examples of the present invention will now be described below.

### Examples 1 and 2 and Comparative Example 1

Polishing compositions of Examples 1 and 2 and Comparative Example 1 were prepared by diluting a colloidal silica sol containing colloidal silica having a mean primary particle diameter of 80 nm with water and adding a pH adjuster as needed. Each of the polishing compositions of Examples 1 and 2 and Comparative Example 1 contained 20% by mass of colloidal silica. Hydrochloric acid or potassium hydroxide was appropriately used as a pH adjuster. Using each of the polishing compositions of Examples 1 and 2 and Comparative Example 1, a surface (c-plane (<0001>)) of a sapphire substrate was polished under the conditions shown in Table 1. All the sapphire substrates used were of the same kind having a diameter of 52 mm (about 2 inches).

The pHs of the polishing compositions, zeta potential values of the colloidal silica measured in the polishing compositions, and zeta potential values of the sapphire substrates measured during polishing using the polishing compositions are shown in Table 2. The weights of the sapphire substrates were measured before and after polishing using the polishing compositions for calculation of the rates of polishing from the difference in weights before and after polishing. The calculated rates of polishing are shown in the column “polishing rate” of Table 2.

TABLE 1

<Sapphire substrate polishing conditions>
Polishing machine: Single side polisher “EJ-380IN” (surface plate
diameter of 380 mm) made by Engis Japan Corporation
Polishing pad: Nonwoven fabric polishing pad “SUBA800” made by
Nitta Haas Incorporated
Polishing pressure: 300 g/cm² (29.4 kPa)
Surface plate rotational rate: 110 rpm
Linear velocity: 83 m/min
Polishing time: 5 min
Polishing composition feed rate: 200 mL/min (continuously fed
without being circulated)

TABLE 2

| | | Zeta potential (X) | Zeta potential (Y) [mV] of | | |
|---|---|---|---|---|---|
| | | [mV] of colloidal | sapphire substrate measured | | |
| | pH of polishing | silica measured in | during polishing using | X × Y | Polishing rate |
| | composition | polishing composition | polishing composition | (product of X and Y) | [nm/min] |
| Example 1 | 5 | −29 | 48 | −1392 | 35 |
| Example 2 | 7 | −43 | 35 | −1505 | 38 |
| Comparative Example 1 | 11 | −48 | −54 | 2592 | 23 |

As shown in Table 2, when a sapphire substrate was polished using the polishing composition of Example 1 or 2, the product of the zeta potential of colloidal silica and the zeta potential of the sapphire substrate had a value not higher than zero. In contrast, when a sapphire substrate was polished using the polishing composition of Comparative Example 1, the product had a value higher than zero. Consequently, a higher polishing rate was achieved using the polishing composition of Example 1 or 2 compared to using the polishing composition of Comparative Example 1.

### Example 3 and Comparative Example 2

Polishing compositions of Example 3 and Comparative Example 2 were prepared by diluting a colloidal silica sol containing colloidal silica having a mean primary particle diameter of 80 nm with water and adding a pH adjuster as needed. Each of the polishing compositions of Example 3 and Comparative Example 2 contained 20% by mass of colloidal silica. Hydrochloric acid or potassium hydroxide was appropriately used as a pH adjuster. Using each of the polishing compositions of Example 3 and Comparative Example 2, a surface (Ga plane) of a gallium nitride substrate was polished under the conditions shown in Table 3. All the gallium nitride substrates used were of the same kind having 10 mm square.

The pHs of the polishing compositions, the sign of the zeta potential of the colloidal silica measured in each of the polishing compositions, and the sign of the zeta potential of the gallium nitride substrates measured during polishing using each of the polishing compositions are shown in Table 4. The weights of the gallium nitride substrates were measured before and after polishing using the polishing compositions for calculation of the rates of polishing from the difference in weights before and after polishing. The calculated rates of polishing are shown in the column “polishing rate” of Table 4.

TABLE 3

<Gallium nitride substrate polishing conditions>
Polishing machine: Single side polisher “EJ-380IN” (surface
plate diameter of 380 mm) made by Engis Japan Corporation
Polishing pad: Nonwoven fabric polishing pad “SURFIN SSW-1”
made by Nitta Haas Incorporated
Polishing pressure: 880 g/cm² (86.3 kPa)
Surface plate rotational rate: 100 rpm
Linear velocity: 75 m/min
Polishing time: 60 min
Polishing composition feed rate: 100 mL/min (continuously fed
without being circulated)

TABLE 4

| | | Sign of zeta potential | Sign of zeta potential (Y) | | |
|---|---|---|---|---|---|
| | | (X) of colloidal | of gallium nitride substrate | Sign of X × Y | |
| | pH of polishing | silica measured in | measured during polishing | (sign of product | Polishing rate |
| | composition | polishing composition | using polishing composition | of X and Y) | [nm/min] |
| Example 3 | 5 | − | + | − | 11.1 |
| Comparative | 10 | − | − | + | 5.2 |
| Example 2 | | | | | |

As shown in Table 4, when a gallium nitride substrate was polished using the polishing composition of Example 3, the product of the zeta potential of colloidal silica and the zeta potential of the gallium nitride substrate had a negative sign. In contrast, when a gallium nitride substrate was polished using the polishing composition of Comparative Example 2, the product had a positive sign. Consequently, a higher polishing rate was achieved using the polishing composition of Example 3 compared to using the polishing composition of Comparative Example 2.

### Examples 4 and 5 and Comparative Examples 3 and 4

Polishing compositions of Examples 4 and 5 and Comparative Examples 3 and 4 were prepared by diluting a colloidal silica sol containing colloidal silica having a mean primary particle diameter of 35 nm with water and adding a pH adjuster as needed. Each of the polishing compositions of Examples 4 and 5 and Comparative Examples 3 and 4 contained 5% by mass of colloidal silica. Acetic acid or potassium hydroxide was appropriately used as a pH adjuster. Using each of the polishing compositions of Examples 4 and 5 and Comparative Examples 3 and 4, a surface ((100) plane) of an indium arsenide substrate was polished under the conditions shown in Table 5. All the indium arsenide substrates used were of the same kind having a diameter of 52 mm (about 2 inches).

The pHs of the polishing compositions, the sign of the zeta potential of the colloidal silica measured in each of the polishing compositions, and the sign of the zeta potential of the indium arsenide substrates measured during polishing using each of the polishing compositions are shown in Table 6. The weights of the indium arsenide substrates were measured before and after polishing using the polishing compositions for calculation of the rates of polishing from the difference in weights before and after polishing. The calculated rates of polishing are shown in the column “polishing rate” of Table 6.

TABLE 5

<Indium arsenide substrate polishing conditions>
Polishing machine: Single side polisher “EJ-380IN” (surface
plate diameter of 380 mm) made by Engis Japan Corporation
Polishing pad: Nonwoven fabric polishing pad “POLITEX” made by
Nitta Haas Incorporated
Polishing pressure: 180 g/cm² (17.6 kPa)
Surface plate rotational rate: 50 rpm
Linear velocity: 37.5 m/min
Polishing time: 3 min
Polishing composition feed rate: 100 mL/min (continuously fed
without being circulated)

TABLE 6

| | | Sign of zeta potential | Sign of zeta potential (Y) | | |
|---|---|---|---|---|---|
| | | (X) of colloidal | of indium arsenide substrate | Sign of X × Y | |
| | pH of polishing | silica measured in | measured during polishing | (sign of product | Polishing rate |
| | composition | polishing composition | using polishing composition | of X and Y) | [nm/min] |
| Example 4 | 3 | + | − | − | 153 |
| Example 5 | 6 | − | + | − | 203 |
| Comparative | 8 | − | − | + | 63 |
| Example 3 | | | | | |
| Comparative | 10 | − | − | + | 55 |
| Example 4 | | | | | |

As shown in Table 6, when an indium arsenide substrate was polished using the polishing composition of Example 4 or 5, the product of the zeta potential of colloidal silica and the zeta potential of the indium arsenide substrate had a negative sign. In contrast, when an indium arsenide substrate was polished using the polishing composition of Comparative Example 3 or 4, the product had a positive sign. Consequently, a higher polishing rate was achieved using the polishing composition of Example 4 or 5 compared to using the polishing composition of Comparative Example 3 or 4.

1. A polishing composition for use in polishing an object to be polished formed of a substrate material for optical devices, a substrate material for power devices, or a compound semiconductor material, the polishing composition comprising at least abrasive grains and water in which the abrasive grains have a zeta potential satisfying the relationship X×Y≦0, where X [mV] represents the zeta potential of the abrasive grains measured in the polishing composition and Y [mV] represents the zeta potential of the object to be polished measured during polishing using the polishing composition.

2. The polishing composition according to claim 1, wherein the expression X×Y has a value not lower than −5,000.

3. The polishing composition according to claim 1, wherein the abrasive grains are formed of aluminum oxide, silicon oxide, zirconium oxide, diamond, or silicon carbide.

4. The polishing composition according to claim 1, wherein the object to be polished is formed of sapphire, gallium nitride, silicon carbide, gallium arsenide, indium arsenide, or indium phosphide.

5. The polishing composition according to claim 1, further comprising a pH adjuster.

6. The polishing composition according to claim 1, further comprising a substance that adsorbs to the object to be polished.

7. The polishing composition according to claim 1, wherein the abrasive grains are surface-reformed.

8. A method of polishing an object formed of a substrate material for optical devices, a substrate material for power devices, or a compound semiconductor material, the method comprising:
preparing a polishing composition containing at least abrasive grains and water, wherein the relationship X×Y≦0 is satisfied, where X [mV] represents the zeta potential of the abrasive grains measured in the polishing composition and Y [mV] represents the zeta potential of the object measured during polishing using the polishing composition; and
using the polishing composition to polish the object.

9. The method according to claim 8, wherein the abrasive grains are formed of aluminum oxide, silicon oxide, zirconium oxide, diamond, or silicon carbide.

10. The method according to claim 8, wherein the object is formed of sapphire, gallium nitride, silicon carbide, gallium arsenide, indium arsenide, or indium phosphide.

11. The method according to claim 8, further comprising adding a pH adjuster to the polishing composition prior to said using.

12. The method according to claim 8, further comprising adding a substance that adsorbs to the object to the polishing composition prior to said using.

13. The method according to claim 8, wherein said preparing a polishing composition includes surface-reforming the abrasive grains.

14. A polishing composition for use in polishing an object to be polished formed of a substrate material for optical devices, a substrate material for power devices, or a compound semiconductor material, the polishing composition comprising at least abrasive grains and water in which the abrasive grains have such a zeta potential as not to be electrostatically repelled from the object to be polished during polishing using the polishing composition.

15. The polishing composition according to claim 14, wherein the abrasive grains are formed of aluminum oxide, silicon oxide, zirconium oxide, diamond, or silicon carbide.

16. The polishing composition according to claim 14, wherein the object to be polished is formed of sapphire, gallium nitride, silicon carbide, gallium arsenide, indium arsenide, or indium phosphide.

17. The polishing composition according to claim 14, further comprising a pH adjuster.

18. The polishing composition according to claim 14, further comprising a substance that adsorbs to the object to be polished.

19. The polishing composition according to claim 14, wherein the abrasive grains are surface-reformed.
